(19) United States
(12) Patent Application Publication
(10) Pub. No.: US 2008/0178473 A1
(43) Pub. Date: Jul. 31, 2008

(54) CLAMSHELL PACKAGING AND CLAMSHELL PACKAGE OPENING SYSTEMS AND METHODS

(76) Inventor: Calvin Y. Liu, Irvine, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/669,398

(22) Filed: Jan. 31, 2007

(51) Int. Cl. B26B 15/00; B65B 43/38; B65D 73/00

(52) U.S. Cl. 30/277.4; 53/492; 206/470

(57) ABSTRACT

A clamshell package includes an edge on each shell of the package that, when sealed, forms an edge structure in accordance with an embodiment of the present invention. The edge structure may be gripped by an opener in accordance with an embodiment of the present invention configured to grip the edge structure and cut the shells apart with a cutting blade. The opener may be a hinged device that closes on the package and engages a motorized or manually operated driving wheel and a cutting blade to allow the separation of one portion of the package from the other.

### TECHNICAL FIELD

The present invention relates generally to clamshell packaging and systems and methods for opening packages.

### BACKGROUND

Clamshell packaging and other forms of packaging typically may be made of polyvinyl chloride (PVC), a tough, clear plastic that enables consumers to see most of the product without opening the packaging. For example, the package may be closed by folding two parts together, referred to as a “clamshell.” The clamshell package may be of more complex design, having more shells and different shapes when properly sealed.

The practical difficulty of opening the package may reduce tampering, save merchants restocking expenses, and eliminate consumer distrust of a product that has been opened for inspection by a prior customer. It may also discourage theft and shop-lifting because the package may be made bulky enough to deter attempts to conceal the product as packaged, and it may significantly hamper attempts to surreptitiously open the package and remove the product.

The clamshell lip may be sealed, for example, using ultrasonic, radio or microwave frequency radiation, thermostatic welding, ultraviolet-curable adhesives, or equivalents, effectively fusing the two shells into one rugged, sealed structure.

Once purchased, however, these packaging virtues may become a convenience liability. While Federal consumer safety laws may have requirements for tamper-proof or child-safety seals on various products, such packaging requirements may make many packages, including clamshells, almost adult-proof as well. It is common to attempt to open the clamshell package by prying apart the two shell-halves of the package, but sealing technology is notably efficient in that it often requires force either beyond the strength of the consumer, or compels the consumer to attempt to open the package with inappropriate cutting tools that may lead to injury. For example, physicians have reported widespread incidents of having to treat patients for package-related injuries, such as from a wound to the hand holding the package inflicted with the opening tool or from the sharp edges of the package itself.

As a result, it would be of considerable convenience and safety to provide a clamshell package of design and construction that may be easily and securely sealed and amenable to being easily and safely opened by a device suited to the seal design, while still retaining all the features of ruggedness, consumer safety, and merchant inventory security.

### SUMMARY

Systems and methods are disclosed herein in accordance with one or more embodiments of the present invention to provide a package and devices adapted for opening the package. For example, in accordance with one or more embodiments of the present invention, a clamshell package is disclosed that includes a first shell portion, a second shell portion, a hinge connecting the first and second shell portion, a seam for joining the shell portions, and an edge shape structure configured to facilitate opening the package with an opener device. The hinge is configured for folding the first and second shell portions together. The edge portions of the shell portions, when sealed, form an edge shaped structure adapted to be gripped by an opening device.

In accordance with one or more embodiments of the present invention, the edge shaped structure of the sealed clamshell package may be configured to substantially replicate, when sealed, the profile of a sealed rim of a standard metal can. Therefore, the clamshell package may be opened conveniently with a standard can opener.

The clamshell package may have a complementary device for opening it. In accordance with one or more embodiments of the present invention, a clamshell package opener includes two opposable portions, or arms. One end of each arm being hinged to the other arm, and may be configured to close and grip the sealed edge shape structure in a slot. The slot may have a shape substantially complementary to the profile of the sealed edge shape structure. The clamshell package edge may advance through the slot, and the opener is adapted to open the package.

In accordance with one or more embodiments of the present invention, one portion, or arm, of the clamshell package opener may contain an assembly that may include a rotatable driving wheel. When driven, the driving wheel advances the clamshell package edge through the slot like a conventional can opener.

The clamshell package opener may include a cutting blade. The cutting blade may be provided in an arm of the opener so that when both the cutting blade and the driving wheel are engaged with the edge of the clamshell package, the combination separates at least a portion of one shell from the other shell.

In one or more embodiments of the present invention, the cutting blade may be positioned to separate the shells along the seam inward from the edge through the sealed region of the clamshell package seam. In another embodiment of the present invention, the cutting wheel or blade may be positioned to cut through one or both shells across the seam of the clamshell package inward from the edge and the sealed region, separating at least a part of one shell from the remainder of the package.

In accordance with one or more embodiments of the present invention, the clamshell package opener may include a motor, a power source, and one or more switches. The motor may be coupled to the driving wheel via, for example, a shaft, pulley and/or a gear to actuate the driving wheel. The switches may be configured to act to complete a circuit that includes the motor. The power source may include a battery and/or a connection to an external source of electrical power.

In accordance with one or more embodiments of the present invention, where electrical power is provided to the opener, the cutting device may include a heated blade, either straight or circular, that cuts by heating and melting in addition to, or instead of, a sharp edge alone. Combinations of the above cutting devices and other cutting techniques may be contemplated within the scope of the invention.

In accordance with one or more embodiments of the present invention, where electrical power is provided, the assembly may include a switch that closes when the assembly is moved to an ON position, partially or entirely completing the circuit that actuates the motor. The clamshell package opener may further include a switch that closes when the clamshell package opener is closed to engage the edge structure of the clamshell package, partially or entirely completing the circuit that actuates the motor.

In accordance with one or more embodiments of the present invention, electrically powered embodiments may also include a device for making noise so that the opener alerts others, such as, for example, a retail store operator offering products for sale provided in clamshell packages. Powered embodiments in accordance with the present invention may also include a light emitting device to indicate that the opener is in use. Methods of use in conjunction with the above clamshell package opener are also disclosed.

In accordance with one or more embodiments of the present invention, the clamshell package opener may be operated by hand actuation of the driving wheel. Manual operation of the opener, and structures to enable manual operation may be included in the design and use of the opener in addition to, or instead of, electrically powered embodiments.

The scope of the invention is defined by the claims which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE FIGURES

FIG. 1 is perspective view of a clamshell package in accordance with an embodiment of the present invention.

FIG. 2 is a cross-sectional view of the clamshell package as shown in FIG. 1, taken along the line II-II.

FIG. 3 is a cross-sectional view of the clamshell package as shown in FIG. 1, taken along the line III-III.

FIG. 4 is a detail of the sealed edge of the clamshell package as shown in FIGS. 2 and 3.

FIG. 5 is an example of an opener in accordance with an embodiment of the present invention.

FIG. 6A shows a detail of the driving wheel, cutting blade and shaft in relation to the clamshell package edge in accordance with an embodiment of the present invention.

FIG. 6B shows a detail of the driving wheel, cutting wheel and shaft when engaged with the clamshell package edge in accordance with an embodiment of the present invention.

FIG. 6C shows an arrangement of the cutting wheel and driving wheel, in accordance with another embodiment of the clamshell package opener.

FIG. 6D shows an arrangement of the cutting wheel and driving wheel, in accordance with another embodiment of the clamshell package opener.

FIG. 6E shows an arrangement of the cutting wheel and driving wheel, in accordance with another embodiment of the clamshell package opener.

FIG. 7 shows an assembly comprising the cutting wheel, driving wheel, and motor in accordance with an embodiment of the present invention.

FIG. 8A shows an example of a clamshell package opener, in accordance with one embodiment of the present invention as shown in FIG. 6B.

FIG. 8B shows an example of a clamshell package opener, in accordance with one embodiment of the present invention as shown in FIG. 6C.

FIG. 8C shows an example of a clamshell package opener, in accordance with one embodiment of the present invention as shown in FIG. 6D.

FIG. 9 shows a circuit for operation of the clamshell package opener in accordance with one or more embodiments of the present invention.

Embodiments of the present invention and their advantages are best understood by referring to the detailed description that follows. It should be appreciated that like reference numerals are used to identify like elements illustrated in one or more of the figures.

### DETAILED DESCRIPTION

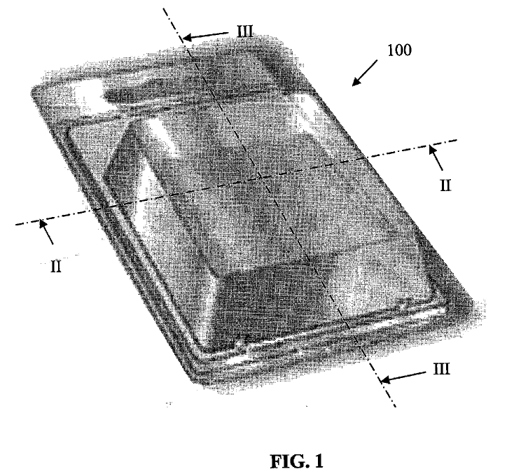

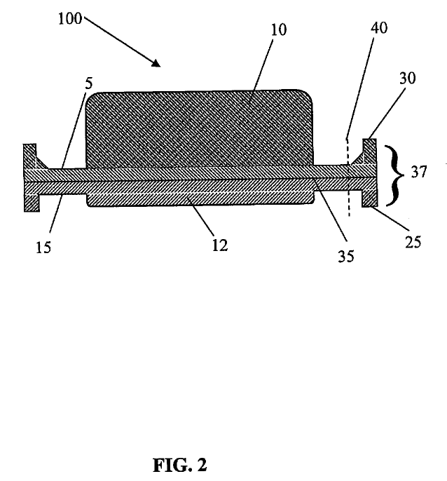

With reference to FIG. 1, a clamshell package 100 is disclosed in accordance with an embodiment of the present invention. FIG. 2 is a cross-sectional view of clamshell package 100 shown in FIG. 1 taken along the line II-II. Clamshell package 100 may include a top shell 5 having a top cavity 10, a bottom shell 15 having an additional bottom cavity 12, a seam 35, a shaped edge lip 25 on bottom shell 15, and a shaped edge lip 30 on top shell 5.

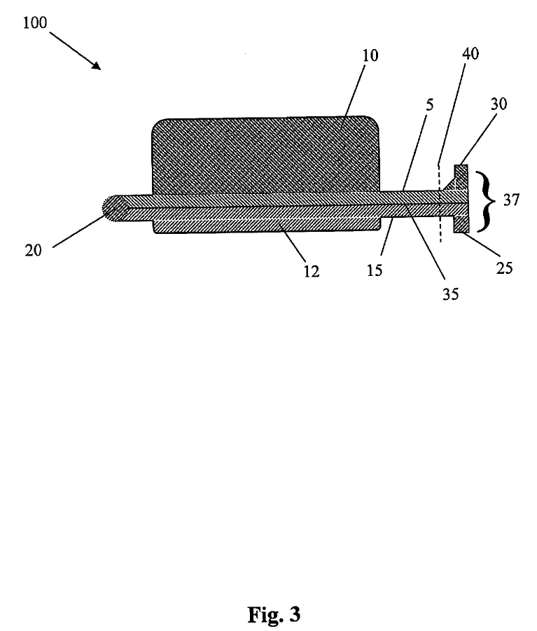

FIG. 3 is a cross-sectional view of clamshell package 100 shown in FIG. 1 taken along the line III-III. Clamshell package 100 may include, additionally, an integral hinge 20.

Referring to FIGS. 2 and 3, top shell 5 may include top cavity 10 for containment of the enclosed product (not shown) when clamshell package 100 is sealed. Bottom shell 15 may be substantially flat or may include bottom cavity 12. Integral hinge 20 is a continuous part of the package material to facilitate folding of top shell 5 and bottom shell 15 together along seam 35, which may be sealed. Shaped edge lip 25 is on bottom shell 15, and shaped edge lip 30 is on top shell 5. Edge lip 25 and edge lip 30 may be shaped identically, or alternatively, they may be shaped somewhat differently to accommodate the specifications of a clamshell package opener, as discussed further below in accordance with one or more embodiments of the present invention.

Seam 35 is a portion of clamshell package 100 where edge lip 25 and edge lip 30 may be sealed using conventional methods. When sealed, edge lip 25 and edge lip 30 may combine to form a shaped edge structure, hereinafter referred to as edge 37. Seam 35 forms a sealed bond between top shell 5 and bottom shell 15 along edge 37 of clamshell package 100. To open clamshell package 100, seam 35 may be split and/or a cut may be made inside the perimeter of seam 35 in such a manner as to release an adequate portion of shell cavity 10 and/or shell cavity 12 from the edge 37 of clamshell package 100.

In accordance with one or more embodiments of the present invention, package openers are disclosed. In the embodiments, discussed below, the design of edge 37, comprising seam 35, edge lip 25, and edge lip 30, may integrally affect the configuration of the clamshell package opener, and details of the arrangement of components.

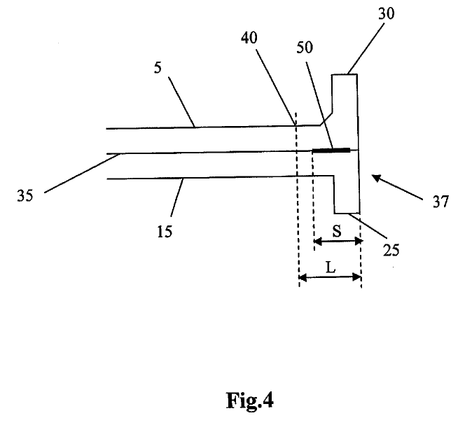

Referring to FIG. 4, a dashed line 40 and seam 35 may be locations at which cutting the clamshell package may occur to release a portion or all of top shell 5 from bottom shell 15. Dashed line 40 is indicated as a distance L from outer limit of edge 37. A region 50 indicates the portion of seam 35 that has been sealed. The maximum distance to which region 50 extends inward along seam 35 is indicated by a distance S. Distance L is greater than the maximum penetration distance S of seal region 50 along seam 35, such that a cut from the outer limit of edge 37 by a distance L≧S may also be inside the seam seal 50, and thus insure that portions of top shell 10 and bottom shell 15 may successfully separate.

In accordance with one or more embodiments of the present invention, cutting may take place vertically along line 40 or, alternatively, horizontally along seam 35. Regardless of the cutting path, the cut must be inward from the outer limit of edge 37 by at least a distance S.

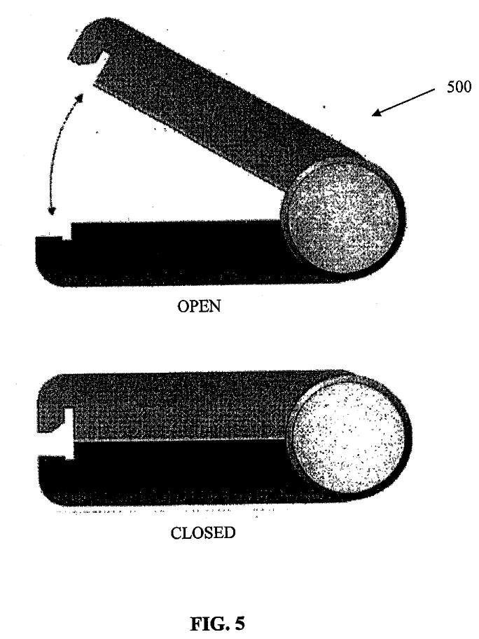

FIG. 5 is an example of an opener 500 in accordance with an embodiment of the present invention, shown in open and closed positions. As will be described, opener 500 has spaces configured to grip edge 37 of clamshell package 100 in a substantially complementary fashion to enable opening of clamshell package 100. Opener 500, for example, may be battery operated. Conventional can openers may also serve as suitable openers provided clamshell package 100 is suitably designed with corresponding edge 37.

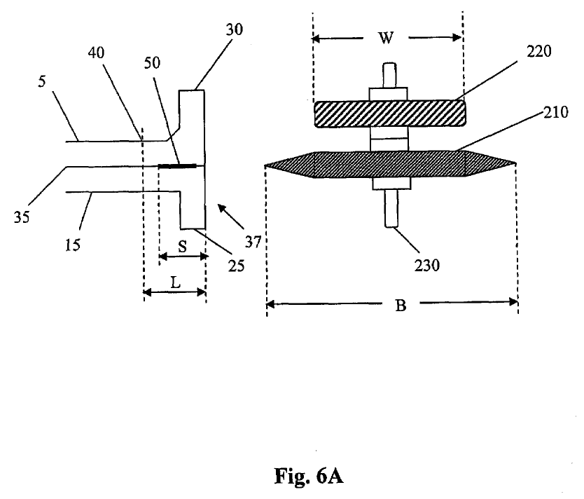

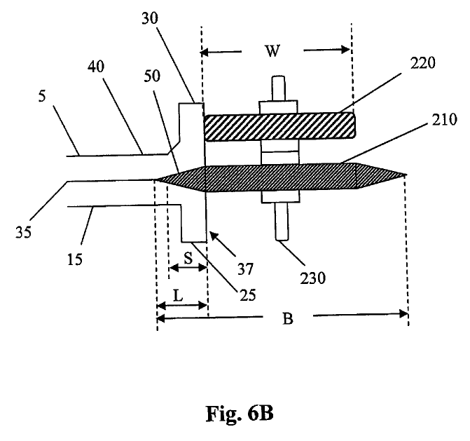

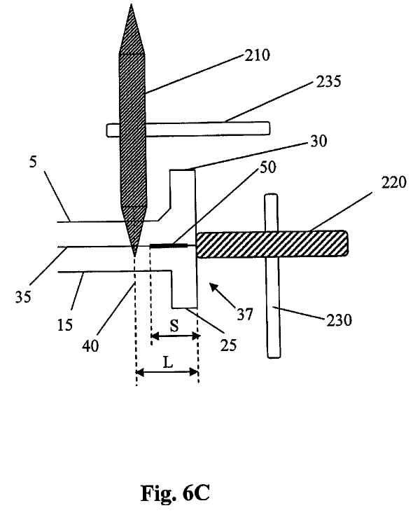

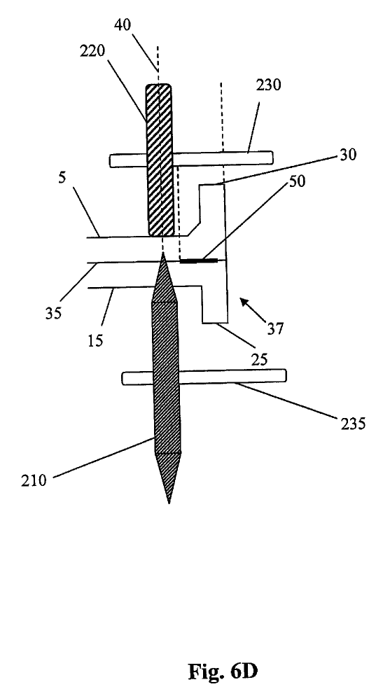

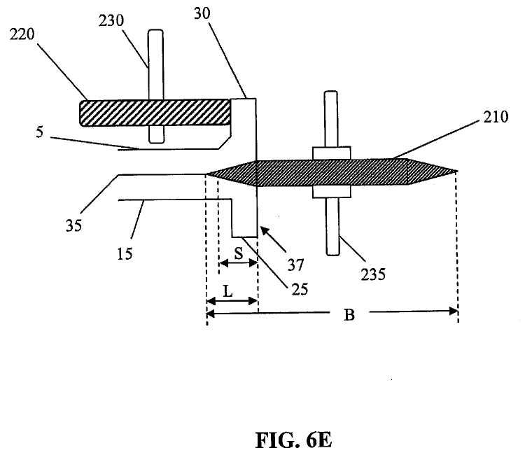

FIG. 6A is a detail of several components that may comprise one embodiment of a portion of the opening mechanism, discussed below, of clamshell package opener 500, shown in relation to the same details presented in FIGS. 2-4. The cutting mechanism may be a cutting blade 210 and a driving wheel 220 on a common shaft 230. Cutting blade 210 may be circular, however, other shaped cutting blades and mechanisms may be used. When deployed, cutting blade 210, driving wheel 220 and shaft 230 may be moved toward edge 37 of clamshell package 100, where cutting blade 210 may be substantially aligned with seam 35. Cutting blade 210 may be freely rotating or rigidly fixed on shaft 230, whereas driving wheel 220 may be rigidly attached to shaft 230 to facilitate motorized or manual advancement of clamshell package opener 500 along seam 35 and edge 37 around the perimeter of clamshell package 100. Cutting blade 210 may be rigidly fixed to shaft 230 so that both cutting blade 210 and driving wheel 220 are driven synchronously to advance along edge 37. Driving wheel 220 may be serrated, for example, and/or have a grooved or rough outer rim to improve contact traction with edge 37 and advancement along edge 37.

Cutting blade 210 may be circular and have a diameter B that may be larger than driving wheel 220 diameter W by an amount equal to 2 L which is equal to or greater than 2 S in order to insure that cutting blade 210 penetrates seal 35 to a distance L equal to or greater than S to assure that seal 35 is completely separated. Thus, the relationship between cutting blade 210 diameter B, if circular, and driving wheel 220 diameter W may be summarized as B=W+2 L≧W+2 S.

FIG. 6B shows a detail of driving wheel 220, cutting blade 210 and shaft 230 when engaged with clamshell package edge 37 in accordance with an embodiment of the present invention. Driving wheel 220 abuts edge 37 and cutting blade 210 may penetrate into seam 35 to a depth L≧S. A fuller description of the incorporation of the various elements in clamshell opener 500 and methods of operation, in accordance with one or more embodiments of the present invention, will be discussed below.

FIG. 6C shows another embodiment of cutting blade 210 and driving wheel 220 in accordance with the present invention. Cutting blade 210 is shown mounted on a shaft 235, at substantially a right angle to shaft 230. Cutting blade 210 makes a substantially vertical cut along dashed line 40, which must be a distance L≧S inward from edge 37. Cutting blade 210 may cut into top shell 5 to a depth reaching at least to seam 35 or alternatively, it may cut entirely through both top shell 5 and bottom shell 15. Cutting blade 210 and shaft 235 may be located as approaching clamshell package 100 from above top shell 5, as shown or, alternatively (not shown), from below bottom shell 15, on the opposite side of clamshell package 100. As discussed below, the two alternative arrangements of cutting blade 210 on shaft 235 pertain to embodiments in accordance with the present invention whereby cutting blade 210 and driving wheel 220 may be disposed in different portions of clamshell package opener 500.

FIG. 6D shows another embodiment in accordance with the present invention, wherein cutting blade 210 and shaft 235 are located opposite driving wheel 220 and shaft 230, and also located on opposite sides of clamshell package 100. As shown, driving wheel 220 is adjacent to top shell 5, and cutting blade 210 is adjacent to bottom shell 15. However, the reverse configuration may be adapted in accordance with an embodiment of the present invention. As shown in FIG. 6D, cutting blade 210 and driving wheel 220 may be located to contact clamshell package 100 so that cutting bladed is positioned substantially to cut along dashed line 40.

FIG. 6E illustrates another embodiment in accordance with the present invention, wherein driving wheel 220 and shaft 230 are located so that driving wheel 220 makes contact with the inward facing surface of edge lip 30. Alternatively (not shown), driving wheel 220 and shaft 230 may be located so that driving wheel makes contact with the inward facing surface of edge lip 25.

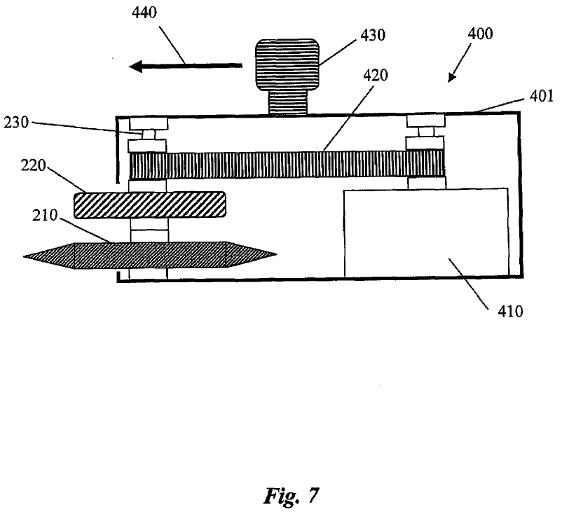

FIG. 7 shows an assembly 400 including cutting blade 210, driving wheel 220, and a motor 410, in accordance with an embodiment of the present invention that may be included in clamshell package opener 500. Assembly 400 (having elements similar to those discussed in reference to FIG. 6B) includes cutting blade 210, driving wheel 220, shaft 230, motor 410, a pulley 420, wherein all are enclosed in an assembly housing 401. Attached to assembly housing 401 is a knob 430, which may be used for advancing assembly 400 in a direction shown by a bold arrow 440. Movement of assembly 400 toward edge 37 places cutting blade 210 and driving wheel 220 in contact with clamshell package 100, as shown in FIG. 6B. Alternatively, pulley 420 may be replaced by a gear coupling (not shown), or by directly coupling motor 410 to shaft 230 (not shown).

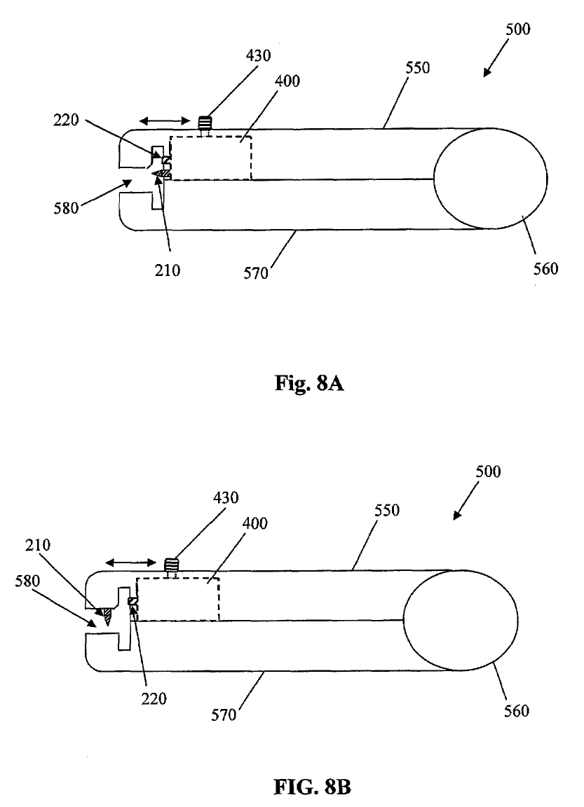

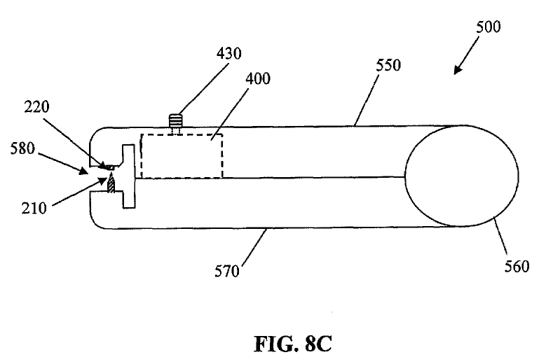

FIG. 8A shows an embodiment of clamshell package opener 500, in accordance with an embodiment of the present invention. Referring to FIG. 8A, clamshell package opener 500 includes an upper arm 550, a lower arm 570, a rotatable hinge 560, and assembly 400. Assembly 400 may be substantially contained within upper arm 550 with the exception of knob 430, which protrudes for user access to advance or retract assembly 400 manually. Clamshell package opener 500, when in the closed position, includes a slot 580 resulting from combining a space provided in each of upper arm 550 and lower arm 570 configured to conformably engage edge 37 of clamshell package 100. With edge 37 of clamshell package 100 placed in slot 580 of clamshell package opener 500, and with clamshell package opener 500 closed to conformably engage edge 37, assembly 400 may be slidably positioned by pushing knob 430 appropriately, for example, in upper arm 550 of clamshell package opener 500 so that cutting blade 210 may advance into seam 35 until driving wheel 220 abuts edge 37.

Alternatively, in accordance with an embodiment of the present invention, assembly 400 may be slidably advanced without recourse to pushing knob 430 by, for example, the result of a mechanically coupled action of closing upper arm 550 and lower arm 570 by rotation about hinge 560 to engage the edge 37 of clamshell package 100 in slot 580.

FIG. 8B shows an example of clamshell package opener 500, in accordance with one embodiment of the present invention, e.g., having some elements similar to those discussed in reference to FIG. 6C, wherein cutting blade 210 is located to make a substantially vertical cut at a distance inward from edge 37 by a distance L≧S, and to a depth reaching at least to seam 35 or further.

FIG. 8C shows an example of a clamshell package opener, in accordance with one embodiment of the present invention (e.g., having some elements similar to those discussed in reference to FIG. 6D), wherein cutting blade 210 is located to make a substantially vertical cut at a distance inward from edge 37 by a distance L≧S, and to a depth reaching at least to seam 35 or further, opposite driving wheel 220, cutting first through bottom shell 15, at least through seam 35, and, optionally, at least partially through top shell 5. In the embodiment shown in FIG. 8C, assembly 400 may be fixed rather than slidable and driving wheel 220 or cutting blade 210 may also be set in fixed positions with respect to slot 580. These element may not need to be moved into position as they may already be in a proper position when upper arm 550 and lower arm 570 of clamshell package opener 500 is closed to open a clamshell package.

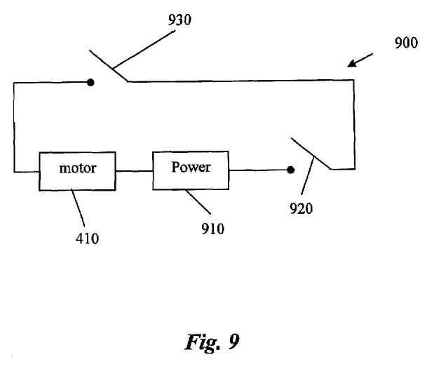

FIG. 9 shows an exemplary circuit 900 for electrically powered operation of clamshell package opener 500 in accordance with one or more embodiments of the present invention. Circuit 900 includes motor 410, an electrical power source 910, and one or more switches, such as, for example, a first switch 920 and a second switch 930. Power source 910 may include batteries (not shown) installed internally to clamshell package opener 500 or, alternatively, may include a connector (not shown) and an external power source (not shown) such as, for example, a voltage converter or AC/DC converter configured to couple to circuit 900 via the connector.

Motor 410 may be enabled to operate via closure of one or more of first switch 920 and/or second switch 930. In accordance with one embodiment of the present invention, power source 910 is shown connected to first switch 920, which may be configured to close when opposable housing arms 550 and 570 close to engage edge 37 of clamshell package 100. However, the circuit is not yet completed. First switch 920 may be connected in series to second switch 930. Second switch 930 may be a slidable contact switch associated with rigid assembly 400 that closes when knob 430 is pushed to move assembly 400 to an ON position, simultaneously engaging driving wheel 220 to abut edge 37 and cutting blade 210 to insert along seam 35. At this point, second switch 930 may also be closed, completing the circuit, which actuates motor 410. Motor 410 may be configured with pulley 420 to actuate shaft 230, turning driving wheel 220. Driving wheel 220 advances clamshell package opener 500 along edge 37, opening clamshell package 100 with cutting blade 210. The components of circuit 900 may be serially rearranged without altering the functional operation of circuit 900.

As described above, first switch 920 provides that circuit 900 will not operate unless clamshell package opener 500 is first closed, as may be the case when it engages edge 37 in slot 580. Afterwards, advancing knob 430 to the ON position closes second switch 930 and driving wheel 220 is then actuated by motor 410. Thus, for example, providing two or more switches, as described above, enables clamshell package opener 500 to operate only when in the closed position.

Additionally, advancing knob 430 to the ON position, which advances cutting blade, as part of assembly 400, into slot 580, may cause interference with edge 37 of clamshell package 100, thus preventing closure of clamshell package opener 500. This, in turn, may prevent closure of first switch 920, so that proper operation of clamshell package opener may not take place. The configuration of first switch 920 and second switch 930 may thus assure proper order of operation.

Alternatively, in accordance with another embodiment of the present invention, second switch 930 may be an ON/OFF button or toggle switch that closes circuit 900 when actuated and activates motor 410. However, assembly 400 may still be separately advanced to an ON position to properly engage edge 37 of clamshell package 100.

Alternatively, in accordance with another embodiment of the present invention, one of the switches, for example first switch 920, may be omitted and replaced with a direct connection, so that only one switch, second switch 930, for example, is required to complete circuit 900 and activate motor 410.

Other features may be added to clamshell package opener 500. For example, a light (e.g., a light emitting diode, not shown) may be included in circuit 900, mounted visibly to inform the user that clamshell package opener 500 is in a state of operation. Alternatively, a buzzer (not shown) or other sound indicator may be included in circuit 900 to provide audible notice that the clamshell package opener 500 is in use.

Alternatively, assembly 400 may include a handle (not shown) on knob 430, for example, coupled to shaft 230, so that shaft 230 may be manually turned to actuate driving wheel 220, thus operating clamshell package opener 500 without motor 410 or power source 910.

In accordance with an embodiment of the present invention, in the case where assembly 400 includes a handle directly coupled to shaft 230, pulley 420 and circuit 900 may be optionally omitted, and clamshell package opener 500 may be manually operated.

Embodiments described above illustrate but do not limit the invention. It should also be understood that numerous modifications and variations are possible in accordance with the principles of the present invention. Accordingly, the scope of the invention is defined only by the following claims.

What is claimed is:

1. An opener for opening a sealed clamshell package, comprising:
an opener first portion;
an opener second portion;
a hinge coupling the opener first portion at a proximal end to the opener second portion;
a first space in the opener first portion, distal from the hinge, configured to receive a first portion of an edge of the sealed clamshell package;
a second space in the opener second portion, distal from the hinge, configured to receive a second portion of the edge of the sealed clamshell package; and
a slot formed by the first and second space to engage the edge of the sealed clamshell package when the two opener portions are closed.

2. The opener of claim 1, wherein the opener further comprises:
a rotatable first shaft;
a circular driving wheel rigidly mounted on the first shaft; and
a cutting blade mounted on the first shaft, wherein the cutting blade is configured to be positioned to protrude into the slot formed by the first space and second space when the two opener portions are closed to engage the edge of the clamshell package by an amount sufficient to cut a seal joining the edge of two shell portions of the clamshell package.

3. The opener of claim 2, wherein the opener further comprises a handle coupled to the rotatable first shaft for turning the driving wheel.

4. The opener of claim 1, wherein the opener further comprises:
a rotatable first shaft;
a circular driving wheel rigidly mounted on the first shaft;
a second shaft; and
a cutting blade mounted on the second shaft.

5. The opener of claim 1, wherein the opener first portion further comprises:
a rotatable first shaft; and
a circular driving wheel rigidly mounted on the first shaft; and
wherein the opener second portion further comprises:
a second shaft; and
a cutting blade mounted on the second shaft, wherein the cutting blade is configured to be positioned to protrude into the slot formed by the first space and second space when the two opener portions are closed to engage the edge of the clamshell package by an amount sufficient to cut through at least one of the two shells of the clamshell package inwardly from a sealed portion of the edge.

6. The opener of claim 1, wherein the opener further comprises:
a slidable assembly comprising:
a rotatable first shaft;
a circular driving wheel rigidly mounted on the first shaft;
a cutting blade mounted on the first shaft; and
a knob adapted for moving the slidable assembly between two positions designating an OFF position and an ON position, and to position the driving wheel and the cutting blade against the edge when in the ON position.

7. The opener of claim 1, wherein the opener further comprises:
a first shaft;
a cutting blade mounted on the first shaft;
a slidable assembly comprising:
a rotatable second shaft;
a circular driving wheel mounted on the second shaft; and
a knob adapted for moving the slidable assembly between two positions designating an OFF position and an ON position, and to position the driving wheel against the edge when in the ON position.

8. The opener of claim 1, wherein the opener first portion further comprises:
a first shaft;
a cutting blade mounted on the first shaft; and
wherein the opener second portion further comprises:
a slidable assembly comprising:
a rotatable second shaft;
a circular driving wheel mounted on the second shaft; and
a knob adapted for moving the slidable assembly between two positions designating an OFF position and an ON position, and to position the driving wheel against the edge when in the ON position.

9. The opener of claim 1, wherein the opener first portion further comprises:
a rotatable first shaft;
a circular driving wheel mounted on the first shaft; and
a slidable assembly, comprising:
a knob for moving the slidable assembly, wherein the slidable assembly is adapted to move between two positions designating an OFF position and an ON position; and
wherein the opener second portion further comprises:
a second shaft; and
a cutting blade mounted on the second shaft.

10. The opener of claim 1, wherein the opener further comprises:
a rotatable first shaft;
a circular driving wheel mounted on the first shaft;
a slidable assembly comprising:
a second shaft;
a cutting blade mounted on the second shaft; and
a knob adapted for moving the slidable assembly between two positions designating an OFF position and an ON position, and to position the cutting blade against the edge when in the ON position.

11. The opener of claim 10, wherein the slidable assembly in the ON position engages a cutting blade and/or the driving wheel with the edge of the sealed clamshell package.

12. The opener of claim 11, wherein the opener further comprises:
a motor rotatably coupled to the first shaft;
a power source adapted to provide power to the motor; and
wherein the motor and the power source comprise a circuit.

13. The opener of claim 12, further comprising:
a first switch coupled serially to the motor and the power source configured to close and partially complete the circuit when the two opener portions are closably engaged to grip the edge of the sealed clamshell package; and
a second switch associated with the slidable assembly and coupled serially to the motor, power source and first switch configured to close and partially complete the circuit when the slidable assembly is in the ON position.

14. The opener of claim 13, wherein closure of the first and second switches completes the circuit to activate the motor and actuate the driving wheel.

15. The opener of claim 14, wherein the circuit further comprises a lamp emitting a light to indicate when the motor is activated.

16. The opener of claim 14, wherein the circuit further comprises a sound emitting device to indicate when the motor is activated.

17. The opener of claim 12, further comprising:
a manual switch coupled serially to the motor and the power source configured to be manually operated to complete the circuit, causing the motor to actuate the driving wheel.

18. A method of opening a sealed clamshell package comprising:
placing an edge of the sealed clamshell package between a first and second space disposed on a first and second arm, respectively, of an opener, wherein the two spaces form a slot with a profile substantially complementary to the shape of an edge of the sealed clamshell package when the opener is closed about the edge;
closing the clamshell package opener to engage the edge of the sealed clamshell package in the slot;
actuating a driving wheel disposed in the opener in contact with the clamshell package edge to advance the edge through the slot by the action of the driving wheel along the edge; and
cutting the edge with a cutting blade disposed in the opener in contact with the edge of the sealed clamshell package to open the clamshell package.

19. The method of claim 18, wherein the actuating of the driving wheel further comprises moving a slidable assembly to an ON position configured to activate a motor rotatably coupled to the driving wheel to advance the edge through the slot, the cutting blade cutting along the edge of the clamshell package to separate at least a part of one shell portion from a second shell portion.

20. The method of claim 18, wherein the actuating of the driving wheel comprises manually turning a handle rotatably coupled to the driving wheel, thereby moving the edge through the slot and enabling the cutting blade to cut along the edge of the clamshell package to separate at least a part of one shell portion from a second shell portion.

21. A device for opening a clamshell package, the device comprising:
means for at least partially enclosing an edge of the clamshell package wherein the edge has a sealed seam;
means for advancing along the edge of the package; and
means for cutting the package along the sealed seam or along the package edge inwardly from the sealed seam as the device advances along the edge.

22. A clamshell package comprising:
a first shell;
a second shell;
a hinge connecting the first shell and the second shell, the hinge configured to allow the first and second shells to be folded together;
a seam for joining and sealing the first and second shells when folded at the hinge to form a sealed package;
an edge at the seam, wherein the sealed package is configured to be opened by a cutting blade located in an opener having a profile substantially complementary to a shape of the edge, the cutting blade aligned to cut inward from the edge along the seam or across the seam inwardly from the edge and sealed portion of the seam.

23. The package of claim 22, wherein the edge of each shell portion further comprises a shape adapted, when the package is sealed, to be gripped by the opener for opening the package.
